(19) United States
(12) Patent Application Publication
(10) Pub. No.: US 2019/0362609 A1
(43) Pub. Date: Nov. 28, 2019

(54) NOTIFICATION SYSTEM

(71) Applicant: Carrier Corporation, Palm Beach Gardens, FL (US)

(72) Inventors: Sudhanva Gundepally, Hyderabad (IN); Pradeep Reddy Sanaga, Hyderabad (IN)

(21) Appl. No.: 16/148,184

(22) Filed: Oct. 1, 2018

(30) Foreign Application Priority Data
May 24, 2018 (IN) 201811019478

(51) Int. Cl. G08B 13/196; H04N 5/232

(52) U.S. Cl. CPC G08B 13/19689; H04N 5/23299

(57) ABSTRACT

A method for generating a notification of an event includes monitoring, using a sensor, a value of a sensed condition at a location of a site; comparing the value of the sensed condition to a setpoint; when the value of the sensed condition exceeds the setpoint, generating an alert; storing, by a controller, the alert in a memory; identifying, at the controller, a camera at the site associated with the sensor; sending a command from the controller to the camera to acquire an image; sending, from the camera to the controller, an image of the location; sending a notification from the controller to a user device, the notification including the image.

### FOREIGN PRIORITY

This application claims priority to Indian Patent Application No. 201811019478, filed May 24, 2018, and all the benefits accruing therefrom under 35 U.S.C. § 119, the contents of which in its entirety are herein incorporated by reference.

### BACKGROUND

The subject matter disclosed herein generally relates to notification systems and, more particularly, to notification systems configured to collect event information at a remote location.

Individuals may wish to know when an event occurs at their home or other location. For example, if indoor temperatures reach extreme conditions, an individual may wish to be notified in order to take preventive measures. Existing systems may monitor an area and send a notification to a user upon occurrence of an event. For example, a security system may monitor a door of a home and send a notification to a user when the door is opened unexpectedly.

### SUMMARY

In an embodiment, a method for generating a notification of an event includes monitoring, using a sensor, a value of a sensed condition at a location of a site; comparing the value of the sensed condition to a setpoint; when the value of the sensed condition exceeds the setpoint, generating an alert; storing, by a controller, the alert in a memory; identifying, at the controller, a camera at the site associated with the sensor; sending a command from the controller to the camera to acquire an image; sending, from the camera to the controller, an image of the location; sending a notification from the controller to a user device, the notification including the image.

In addition to one or more of the features described herein, or as an alternative, further embodiments may include wherein the alert comprises a sensor identifier, a timestamp, and the value of the sensed condition.

In addition to one or more of the features described herein, or as an alternative, further embodiments may include wherein the alert comprises the setpoint.

In addition to one or more of the features described herein, or as an alternative, further embodiments may include wherein the image comprises one of a still image and a video.

In addition to one or more of the features described herein, or as an alternative, further embodiments may include wherein the notification comprises a sensor identifier, a timestamp, and the value of the sensed condition.

In addition to one or more of the features described herein, or as an alternative, further embodiments may include wherein the command from the controller to the camera includes a control command to control a field of view for the camera.

In addition to one or more of the features described herein, or as an alternative, further embodiments may include wherein the control command comprises pan/tilt/zoom components.

In another embodiment, a notification system includes a sensor configured to monitor a value of a sensed condition at a location at a site; a controller remotely located from the site; the controller configured to compare the value of the sensed condition to a setpoint; the controller configured to generate an alert when the value of the sensed condition exceeds the setpoint; the controller configured to store the alert in a memory; the controller configured to identify a camera at the site associated with the sensor; the controller configured to send a command to the camera to acquire an image; the controller configured to receive from the camera an image of the location; the controller configured to send a notification to a user device, the notification including the image.

In addition to one or more of the features described herein, or as an alternative, further embodiments may include wherein the alert comprises a sensor identifier, a timestamp, and the value of the sensed condition.

In addition to one or more of the features described herein, or as an alternative, further embodiments may include wherein the alert comprises the setpoint.

In addition to one or more of the features described herein, or as an alternative, further embodiments may include wherein the image comprises one of a still image and a video.

In addition to one or more of the features described herein, or as an alternative, further embodiments may include wherein the notification comprises a sensor identifier, a timestamp, and the value of the sensed condition.

In addition to one or more of the features described herein, or as an alternative, further embodiments may include wherein the command from the remote controller to the camera includes a control command to control a field of view for the camera.

In addition to one or more of the features described herein, or as an alternative, further embodiments may include wherein the control command comprises pan/tilt/zoom components.

Technical effects of embodiments of the present disclosure include sending a notification to a user device upon occurrence of an event and sending the notification to a storage device at a remote location.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 depicts a notification system in an example embodiment;

FIG. 2 depicts a controller in an example embodiment; and

FIG. 3 depicts a process for generating a notification in an example embodiment.

### DETAILED DESCRIPTION

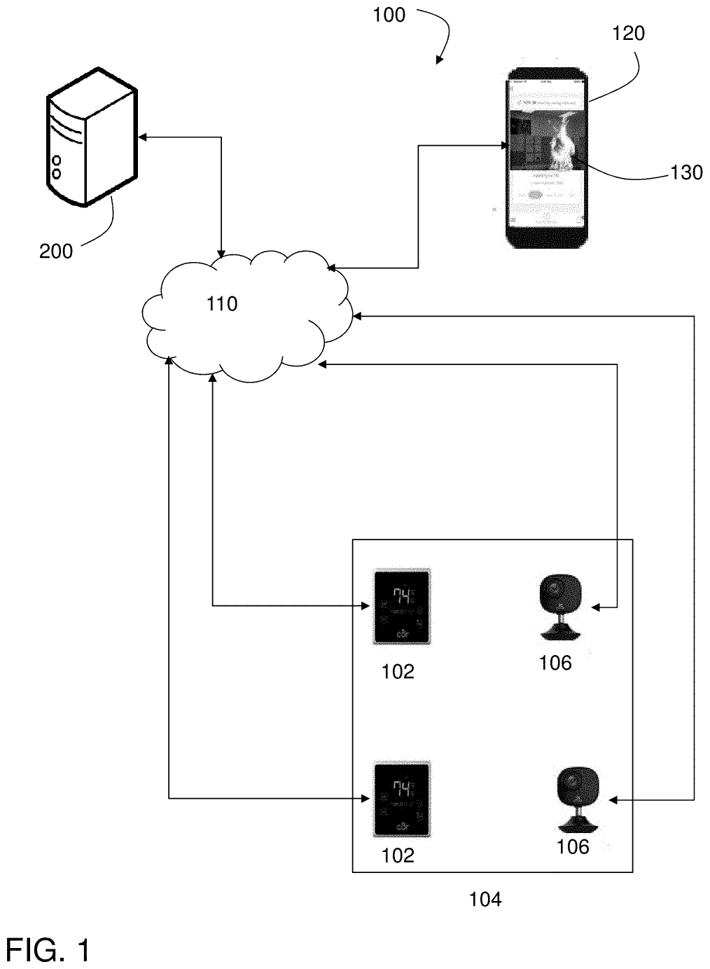

FIG. 1 depicts a notification system 100 in an example embodiment. The notification system 100 includes one or more sensors 102 positioned at a site 104. The sensors 102 may be configured to sense one or more conditions of the site 104, such as entry, egress, temperature, humidity, etc. The site 104 may be any type of building (e.g., residential, commercial, educational, medical) or may be an outdoor area (e.g., lumber yard, granary). One or more cameras 106 are also located at the site 104. The one more cameras 106 can acquire images, such as still images or video, of portions of the site 104. The cameras 106 may be equipped with pan/tilt/zoom controls that allow a single camera 106 to acquire images of multiple areas within the site 104. When the notification system 100 is commissioned, a location of each of the sensors 102 and the cameras 106 within the site 104 is stored at a controller 200. In this manner, when a sensor 102 detects an occurrence of an event, the controller 200 can activate the appropriate camera 106 to acquire an image of the event. The controller 200 is located at a location remote from the site 104 so that event information and images from the site 104 are stored and protected from physical damage.

The sensors 102 and the cameras 106 communicate with the controller 200 over a network 110. The sensors 102 and the cameras 106 may be connected to the network 110 using wired and/or wireless connections. The network 110 may be implemented using a variety of known network topologies, including wireless (e.g., 802.11xx) and wired (LAN, WAN, Ethernet, Internet).

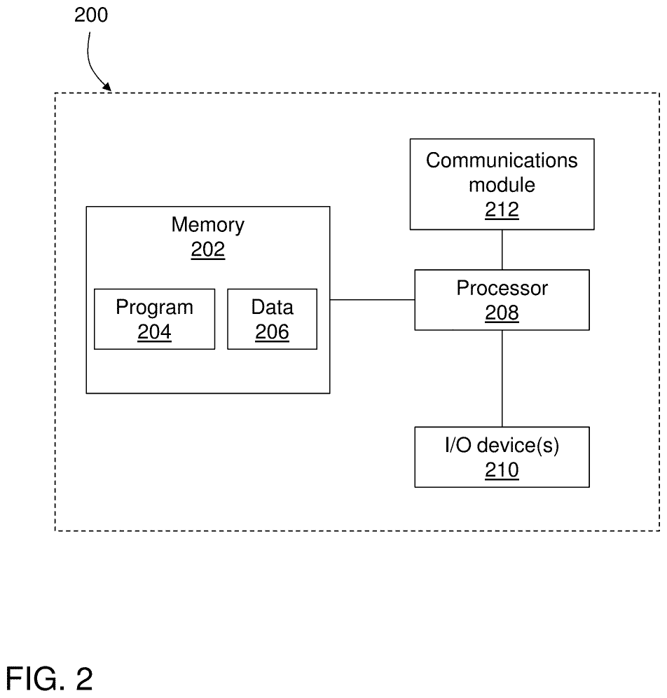

FIG. 2 depicts the controller 200 in an example embodiment. The controller 200 may be a stand-alone system (e.g., a server) or part of a distributed computing network (e.g., cloud computing). The controller 200 includes a memory 202 which may store executable instructions and/or data. The executable instructions may be stored or organized in any manner and at any level of abstraction, such as in connection with one or more applications, processes, routines, procedures, methods, etc. As an example, at least a portion of the instructions are shown in FIG. 2 as being associated with a program 204.

Further, as noted, the memory 202 may store data 206. The data 206 may include an association between cameras 106 and sensors 102. The data 206 may include event information from the sensors 102 and images from the cameras 106. This event information is collected as described in further detail herein. The data 206 may also be stored in one or more remote storage facilities, to provide redundant backup of the data 206.

The processor 208 may be coupled to one or more input/output (I/O) devices 210. In some embodiments, the I/O device(s) 210 may include one or more of a keyboard or keypad, a touchscreen or touch panel, a display screen, a microphone, a speaker, a mouse, a button, a remote control, a joystick, a printer, a telephone or mobile device (e.g., a smartphone), a sensor, video, etc. The I/O device(s) 210 may be configured to provide an interface to allow a user to interact with the controller 200. For example, the I/O device(s) 210 may support a graphical user interface (GUI) and/or voice-to-text capabilities.

The components of the controller 200 may be operably and/or communicably connected by one or more buses. The controller 200 may further include other features or components as known in the art. For example, the controller 200 may include one or more transceivers and/or devices configured to transmit and/or receive information or data from sources external to the controller 200. For example, in some embodiments, the controller 200 may be configured to receive information over the network 110 (wired or wireless). The information received over the network 110 may be stored in the memory 202 (e.g. as data 206) and/or may be processed and/or employed by one or more programs or applications (e.g., program 204). As shown, the controller 200 includes a communications module 212 that can include various communications components for transmitting and/or receiving information and/or data over a variety of networks, including network 110.

Also shown in FIG. 1 is a user device 120. The user device 120 may be a conventional computing device configured to receive notifications from the controller 200 over the network 110. Example embodiments of the user device 120 include personal computers, tablets, smart phones, wearables (e.g., smart watches), etc. The user device 120 includes a display 130.

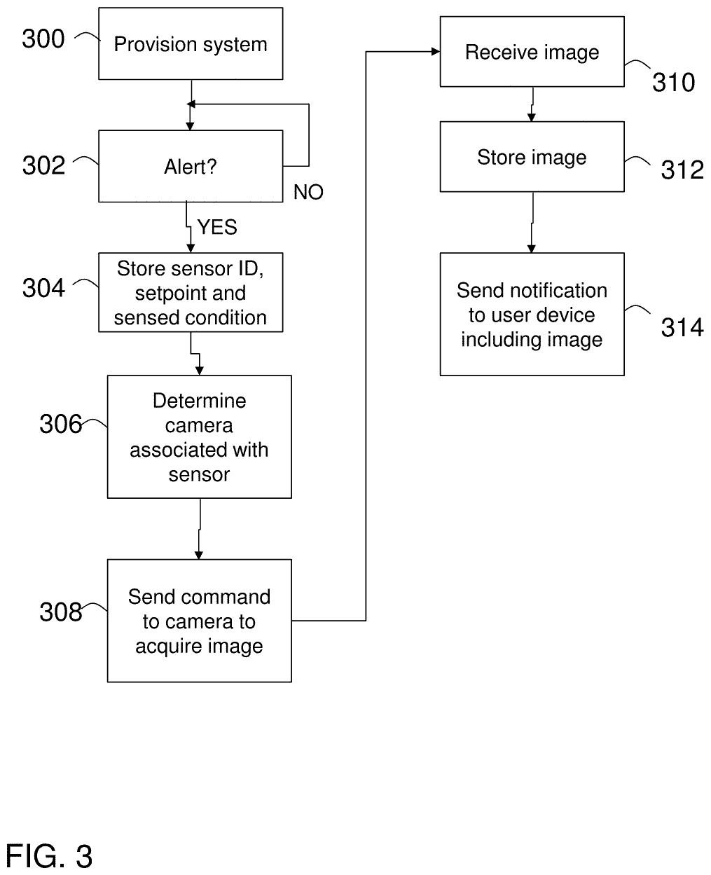

FIG. 3 is a flowchart of processing performed by the notification system 100. At 300, the notification system 100 is provisioned to associate at least one camera 106 with each sensor 102. This association is used later in the process to acquire the correct image in response to an alert. For example, a sensor 102 in a kitchen may be associated with a camera 106 that has a field of view directed at the kitchen. Each sensor 102 may have a unique sensor identifier. A camera 106 may also be associated with multiple areas by remotely controlling the camera. For example, pan/tilt/zoom commands may allow a single camera 106 to acquire images from two locations (e.g., kitchen and dining area). The association between the sensors 102 and the cameras 106 may include control commands (e.g., pan/tilt/zoom) needed to place the camera 106 in the correct position to acquire an image from the location associated with a sensor 102.

At 302, the controller 200 determines if an alert has occurred. Each sensor 102 may monitor one or more conditions at a location within the site 104. If the value of the sensed condition exceeds a setpoint, then an alert is generated. For example, if the temperature in a kitchen exceeds a temperature setpoint, an alert is generated. The controller 200 generates the alert by comparing values of sensed conditions from the sensors 102 to setpoints associated with each sensor 102. The alert may contain a sensor identifier, the value of the sensed condition (e.g., sensed temperature) and the setpoint. The controller 200 may add a timestamp to the alert. The setpoint may be exceeded when the value of the sensed condition goes above or below the setpoint by some predetermined amount. In other embodiments, the alert may be generated at the sensor 102 and communicated to the controller 200, if the sensor 102 is equipped with a processor and programmed to compare a value of the sensed condition to the setpoint.

At 304 the controller 200 stores the sensor identifier, value of the sensed condition (e.g., the temperature) and the setpoint corresponding to the alert. The controller 200 then determines which camera 106 (or multiple cameras 106) are associated with the sensor 102 that initiated the alert. As noted above, during the provisioning at 300, each camera 106 is associated with one or more sensors 102.

Once the controller 200 determines the appropriate camera 106 (or cameras) at 306, the controller 200 sends a command to the camera 106 at 308 to acquire an image. The command sent from the controller 200 to the camera 106 may include a control command that commands a field of view for the camera 106. For example, the control command may include pan/tilt/zoom components to direct the camera 106 at a certain location.

Once the camera 106 receives the command from the controller 200, the camera 106 acquires an image and sends the image to the controller at 310. The image may be a still image or a sequence of images, such as video. At 312, the controller 200 stores the image in memory 202 and associates the image with the corresponding alert.

At 314, the controller 200 sends a notification to the user device 120. The notification may include the image (either still or video) along with the value of the sensed condition, timestamp, setpoint exceeded, sensor identifier, etc. If desired, the user can request a live stream of video from the camera 106 associated with the sensor 102 that generated the alert. The processing of FIG. 3 repeats for subsequent alerts.

Embodiments of the present disclosure provide a notification system that collects alerts at a remote controller and stores information associated with an alert. A notification is also sent to a user device. The data related to the alert is saved at a remote memory to retain information even if devices at the site are damaged. The data related to the alert could be used as evidence in the case of insurance claims. The data related to the alert can also help in investigating events, such as fire accidents.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations. Further, one of ordinary skill in the art will appreciate that the steps described in conjunction with the illustrative figures may be performed in other than the recited order, and that one or more steps illustrated may be optional.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method for generating a notification of an event, the method comprising:
monitoring, using a sensor, a value of a sensed condition at a location of a site;
comparing the value of the sensed condition to a setpoint;
when the value of the sensed condition exceeds the setpoint, generating an alert;
storing, by a controller, the alert in a memory;
identifying, at the controller, a camera at the site associated with the sensor;
sending a command from the controller to the camera to acquire an image;
sending, from the camera to the controller, an image of the location;
sending a notification from the controller to a user device, the notification including the image.

2. The method of claim 1 wherein the alert comprises a sensor identifier, a timestamp, and the value of the sensed condition.

3. The method of claim 2 wherein the alert comprises the setpoint.

4. The method of claim 1 wherein the image comprises one of a still image and a video.

5. The method of claim 1 wherein the notification comprises a sensor identifier, a timestamp, and the value of the sensed condition.

6. The method of claim 1 wherein the command from the controller to the camera includes a control command to control a field of view for the camera.

7. The method of claim 6 wherein the control command comprises pan/tilt/zoom components.

8. A notification system comprising:
a sensor configured to monitor a value of a sensed condition at a location at a site;
a controller remotely located from the site;
the controller configured to compare the value of the sensed condition to a setpoint;
the controller configured to generate an alert when the value of the sensed condition exceeds the setpoint;
the controller configured to store the alert in a memory;
the controller configured to identify a camera at the site associated with the sensor;
the controller configured to send a command to the camera to acquire an image;
the controller configured to receive from the camera an image of the location;
the controller configured to send a notification to a user device, the notification including the image.

9. The system of claim 8 wherein the alert comprises a sensor identifier, a timestamp, and the value of the sensed condition.

10. The system of claim 9 wherein the alert comprises the setpoint.

11. The system of claim 8 wherein the image comprises one of a still image and a video.

12. The system of claim 8 wherein the notification comprises a sensor identifier, a timestamp, and the value of the sensed condition.

13. The system of claim 8 wherein the command from the remote controller to the camera includes a control command to control a field of view for the camera.

14. The system of claim 13 wherein the control command comprises pan/tilt/zoom components.
